(19) United States
(12) Patent Application Publication
(10) Pub. No.: US 2008/0204914 A1
(43) Pub. Date: Aug. 28, 2008

(54) Low Power Write Driver for a Magnetic Disk Drive

(75) Inventor: Motomu Hashizume, Tokyo (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/679,413

(22) Filed: Feb. 27, 2007

(51) Int. Cl. G11B 5/09

(52) U.S. Cl. 360/46; 360/68

(57) ABSTRACT

A write driver (11) for a disk drive system is disclosed. The write driver (11) includes a normal H-bridge drive circuit (30) and a boost H-bridge drive circuit (32). The normal and boost H-bridge drive circuits (30, 32) are both biased from a V_{cc} power supply; however, system ground (GND) biases the normal H-bridge drive circuit (30), while a Vₑₑ power supply voltage, which is negative relative to system ground (GND), biases the boost H-bridge drive circuit (32). Diodes (46Y, 46X) are provided in the pull-down paths of the normal H-bridge drive circuit (30). During the boost portion of the write cycle, both of the normal and boost H-bridge drive circuits (30, 32) are on, and the pull-down current from the write head (HD) is conducted to the Vₑₑ power supply voltage. After the boost portion of the cycle, and thus after the desired overshoot current has been applied, only the normal H-bridge drive circuit (30) drives the steady-state write current, which is conducted to system ground (GND).

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of disk drive systems, and is more specifically directed to write driver circuitry in such disk drives.

Magnetic disk drive technology is the predominant mass non-volatile storage technology in modern personal computer systems, and continues to be an important storage technology for mass storage applications in other devices, such as portable digital audio players. As is fundamental in the field of magnetic disk drives, data is written by magnetizing a location (“domain”) of a layer of ferromagnetic material disposed at the surface of a disk platter. Each magnetized domain forms a magnetic dipole, with the stored data value corresponding to the orientation of that dipole. The “writing” of a data bit to a domain is typically accomplished by applying a current to a small electromagnet coil disposed physically near the magnetic disk, with the polarity of the current through the coil determining the orientation of the induced magnetic dipole, and thus the data state written to the disk.

Modern disk drives systems now incorporate the disk drive controller, including the electronics for controlling and driving the spindle motor (for rotating the disk drive platters) and the voice coil motor (for positioning an actuator arm on which the read/write “heads” are mounted), in the disk drive system itself, rather than in a board or card in the computer chassis. The write channel portion of this disk drive control circuitry includes digital logic that receives and formats the data to be written to the disk, and write driver circuitry located in a preamplifier function. The write driver circuitry produces the signals that are applied to the write head (i.e., electromagnet coil at the actuator arm) to cause the orientation of the magnetic domains according to the data to be stored on the disk.

Examples of conventional write driver circuits are described in U.S. Pat. No. 6,271,978 B1, issued Aug. 7, 2001 to Block et al.; U.S. Pat. No. 6,496,317 B2, issued Dec. 17, 2002 to Lacombe; U.S. Pat. No. 6,549,353 B1, issued Apr. 15, 2003 to Teterud; U.S. Patent Application Publication No. US 2001/0055174 A1, published Dec. 27, 2001 based on an application by Teterud; U.S. Patent Application Publication No. US 2004/0218301 A1, published Nov. 4, 2004 based on an application by Barnett et al.; U.S. Patent Application Publication No. US 2005/0094305 A1, published May 5, 2005 based on an application by Kuehlwein et al.; U.S. Patent Application Publication No. US 2005/0117244 A1, published Jun. 2, 2005 based on an application by Ranmuthu; and U.S. Patent Application Publication No. US 2005/0141120 A1, published Jun. 30, 2005 based on an application by Kuehlwein et al.; all assigned to Texas Instruments Incorporated and incorporated by reference herein.

FIG. 1 schematically illustrates the construction of conventional “H-bridge” write driver circuitry. As shown in FIG. 1, this write driver circuit generates a current that is applied to terminals WHX, WHY and conducted by write head HD (in the form of an electromagnet coil, and thus corresponding to an inductor in the circuit). The H-bridge arrangement of FIG. 1 is especially efficient in applying this current in either polarity at terminals WHX to WHY, and thus writing data of either binary state to the magnetic domain proximate to head HD. As known in the art, the term “H-bridge” refers to the arrangement of pull-up and pull-down devices at each terminal WHX, WHY, which resembles the letter “H”.

In this regard, the H-bridge of FIG. 1 includes p-channel pull-up transistor 6DX, which has its source-drain path connected in series between terminal WHX and the V_{cc} power supply via current source 2DX, and n-channel pull-down transistor 8DY, which has its source-drain path connected in series between terminal WHX and the Vₑₑ power supply via current source 4DY. In this conventional circuit, the Vₑₑ power supply voltage is below system ground. Conversely, p-channel pull-up transistor 6DY has its source-drain path connected in series between terminal WHY and the V_{cc} power supply via current source 2DY, and n-channel pull-down transistor 8DX has its source-drain path connected in series between terminal WHY and the Vₑₑ power supply via current source 4DX. To write a “1” data state, for example, transistors 6DX and 8DX are turned on and transistors 6DY and 8DY are turned off; the current determined by current sources 2DX and 4DX is then conducted through head HD in a polarity from terminal WHX to terminal WHY. Conversely, a “0” data state may be written by turning on transistors 6DY and 8DY and turning off transistors 6DX and 8DX, so that the current determined by current sources 2DY and 4DY is conducted through head HD in a polarity from terminal WHY to terminal WHX. In the conventional H-bridge write driver of FIG. 1, transistors 6DX, 6DY, 8DX, 8DY, and current sources 2DX, 2DY, 4DX, 4DY establish a steady-state write current through, and voltage across, head HD during the write operation.

As described in the above-incorporated U.S. Pat. No. 6,496,317 B2, U.S. Patent Application Publication No. US 2001/0055174 A1, and U.S. Patent Application Publication No. US 2005/0117244 A1, some overshoot at the beginning of a pulse in this write driver output current is beneficial in writing data to a magnetic domain of the disk. As described in those publications, an initial overshoot in the write current can improve the efficiency of the write operation, by speeding up the flux transition in the write head coil (i.e., transition from the opposite data state) and to more quickly establish the DC write current for the desired data state.

As known in the art, some overshoot in the write current applied to the write head occurs naturally due to the reactance presented by the write head inductor itself. However, as described in the above-incorporated U.S. Pat. No. 6,496,317 B2, U.S. Patent Application Publication No. US 2001/0055174 A1, and U.S. Patent Application Publication No. US 2005/0117244 A1, it is useful to control the write current overshoot for optimum performance. It is also known in the art to assist the generation of overshoot in the write driver, by way of a “boost” circuit, an example of which is also shown in FIG. 1, by a parallel H-bridge driver established by boost transistors 6BX, 8BY, 6BY, 8BX. P-channel pull-up boost transistor 6BX has its source-drain path connected in series between terminal WHX and the V_{cc} power supply via current source 2BX, and n-channel pull-down boost transistor 8BY has its source-drain path connected in series between terminal WHX and the Vₑₑ power supply via current source 4BY; conversely, p-channel pull-up boost transistor 6BY has its source-drain path connected in series between terminal WHY and the V_{cc} power supply via current source 2BY, and n-channel pull-down boost transistor 8BX has its source-drain path connected in series between terminal WHY and the Vₑₑ power supply via current source 4BX. In operation, the “boost” H-bridge is turned on during the initial portion of a write operation, for example during the first one-third of the duration of the write. The polarity of the current added by boost transistors 6BX, 6BY, 8BX, 8BY is of course the same as that applied by normal transistors 6DX, 6DY, 8DX, 8DY, such that transistors 6BX, 8BX are on during the first portion of the time that transistors 6DX, 8DX are on, and such that transistors 6BY, 8BY are on during the first portion of the time that transistors 6DY, 8DY are on. All of boost transistors 6BX, 6BY, 8BX, 8BY otherwise remain off. Boost transistors 6BX, 6BY, 8BX, 8BY thus “boost” the write current above the steady-state write current controlled by normal transistors 6DX, 6DY, 8DX, 8DY.

The effect of the natural overshoot in combination with the boost H-bridge is of course to increase the current applied to terminals WHX, WHY during the initial portion of the write operation, as mentioned above. In addition, the reactance of head HD and the boost current also serves to boost the voltage across terminals WHX, WHY to a voltage above the steady-state voltage across head HD established by normal transistors 6DX, 6DY, 8DX, 8DY. This boosted voltage, referred to in the art as the “head launch” voltage, assists in the providing of overshoot current. This boosted voltage is, of course, limited to the total voltage between the V_{cc} and Vₑₑ power supplies (i.e., the sum |V_{cc}|+|Vₑₑ|), less about a one volt voltage drop due to transistors 6, 8 and current sources 2, 4. And, as known in the art, inadequate head launch voltage will limit the applied overshoot current, and thus limit the benefits of that overshoot in efficiently and accurately writing data to the disk.

In conventional H-bridge write driver circuits such as shown in FIG. 1, therefore, the V_{cc} power supply must be at a sufficiently high voltage that the desired head launch voltage can be applied to head HD. It has been observed, in connection with this invention, that the highest head launch voltage is required only when operating the disk drive at the highest data rate; lesser data rates do not require as much (if any) head launch voltage beyond that of the steady-state write voltage that develops across head HD. Similarly, the maximum overshoot current magnitude is also needed only for highest data rate operation; nominal or slower data transfer rate write operations do not require the maximum overshoot current. But because the write driver circuit must accommodate the highest specified data rate as the worst case (i.e., the highest overshoot current and head launch voltage), the V_{cc} power supply voltage will necessarily be over-designed for nominal data rates, and thus will necessarily be over-designed for the vast majority of disk write operations.

As is fundamental in the electrical engineering art, power dissipation is proportional to voltage. Accordingly, by setting of the V_{cc} power supply voltage to a high voltage to enable the desired head launch voltage, the power dissipation of the write driver during the steady-state portions of the write operation is also proportionally increased. Especially with the small form factor disk drive systems that are now popular in the industry, and also considering the thermal effects on the low fly heights of the read-write heads in modern disk drives, excessive power dissipation at the read/write head and in the write driver circuitry is undesirable. This limitation is exacerbated in portable systems including a disk drive, such as digital audio players, where excessive power dissipation undesirably shortens battery life.

### BRIEF SUMMARY OF THE INVENTION

It is therefore an object of this invention to provide write driver circuitry for a disk drive system that reduces the steady-state power dissipation.

It is a further object of this invention to provide such write driver circuitry in which ample head launch voltage and overshoot current is available for high data rate situations.

It is a further object of this invention to provide such write driver circuitry in which the control signals and logic remain relatively modest.

Other objects and advantages of this invention will be apparent to those of ordinary skill in the art having reference to the following specification together with its drawings.

The present invention may be implemented into a write driver circuit for a disk drive, by providing a steady-state H-bridge drive circuit for the write head in parallel with a boost H-bridge drive circuit. The steady-state H-bridge has a sink voltage (i.e., lower reference voltage) that is not as low a voltage as that for the boost H-bridge. As such, the voltage drop across the steady-state drive circuit and load in the steady-state is reduced from the voltage drop across the boost H-bridge drive circuit and load, reducing the power dissipation in the steady-state portion of the write pulse.

### BRIEF DESCRIPTION OF THE SEVERAL VIEWS OF THE DRAWING

FIG. 1 is an electrical diagram, in schematic form, of a conventional write driver circuit.

FIG. 2 is an electrical diagram, in block and schematic form, of a disk drive system constructed according to the preferred embodiment of the invention.

FIG. 3 is an electrical diagram, in block form, of a disk drive write driver constructed according to the preferred embodiment of the invention.

FIG. 4 is an electrical diagram, in schematic form, of a write driver circuit constructed according to the preferred embodiment of the invention.

FIG. 5 is a timing diagram illustrating the operation of the write driver circuit of FIGS. 3 and 4, according to the preferred embodiment of the invention.

### DETAILED DESCRIPTION OF THE INVENTION

The present invention will be described in connection with its preferred embodiment, namely as implemented into a disk drive system for a computer or other digital system, because it is contemplated that this invention will be especially beneficial when used in such an application. However, it is also contemplated that this invention may provide important benefits and advantages in other applications besides that described in this specification. Accordingly, it is to be understood that the following description is provided by way of example only, and is not intended to limit the true scope of this invention as claimed.

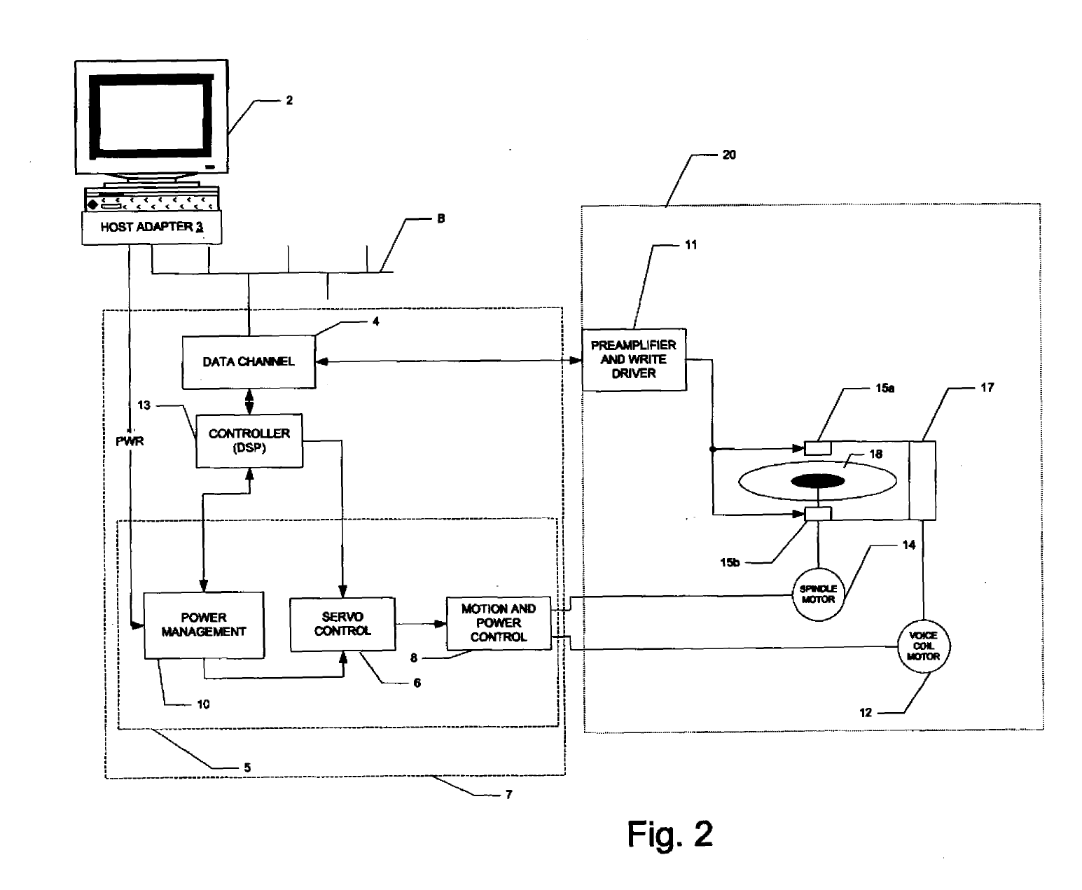

FIG. 2 illustrates an example of a computer including a disk drive system, into which the preferred embodiment of the invention is implemented. In this example, personal computer or workstation 2 is realized in the conventional manner, including the appropriate central processing unit (CPU), random access memory (RAM), video and sound cards or functionality, network interface capability, and the like. Also contained within computer 2 is host adapter 3, which connects on one side to the system bus of computer 2, and on the other side to bus B, to which disk drive controller 7 is connected. Bus B is preferably implemented according to conventional standards, examples of which include the Enhanced Integrated Drive Electronics (EIDE) standard or the Small Computer System Interface (SCSI) standard. Other disk storage devices (hard disk controllers, floppy drive controllers, etc.) and other peripherals may also be connected to bus B, as desired and in the conventional manner. Alternatively, system 2 may be a smaller-scale system, such as a portable digital audio player or the like.

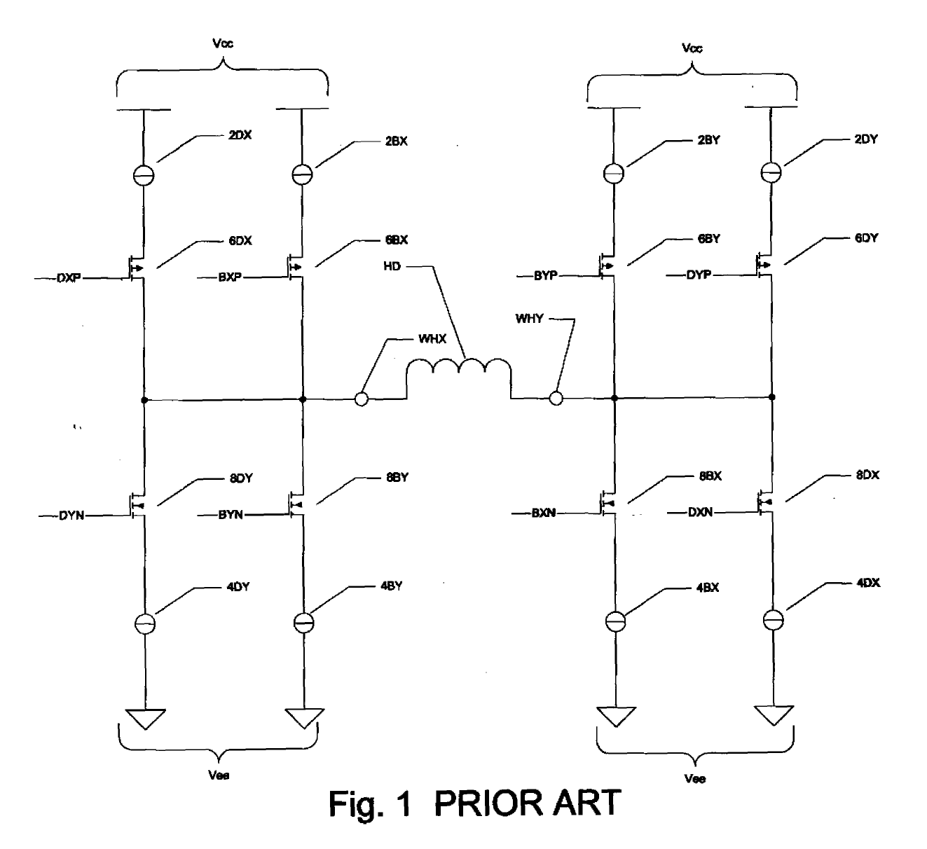

Disk drive controller 7, in this example, corresponds to a disk drive controller architecture in which the drive electronics are physically implemented at the disk drive, rather than as a controller board within computer 2 itself. Of course, in larger scale systems, controller 7 may be implemented within computer 2. In the generalized block diagram of FIG. 1, controller 7 includes several integrated circuits, including data channel 4 in the data path between computer 2 and the medium itself. Disk drive controller 7 also includes controller 13, which is preferably implemented as a digital signal processor (DSP) or other programmable processor, along with the appropriate memory resources (not shown), which typically include some or all of read-only memory (ROM), random access memory (RAM), and other non-volatile storage such as flash RAM. Controller 13 controls the operation of the disk drive system, including such functions as address mapping, error correction coding and decoding, and the like. Interface circuitry coupled between bus B and data channel 4, and other custom logic circuitry including clock generation circuits and the like also may be included within disk drive controller 7.

Head-disk assembly 20 of the disk drive system includes the electronic and mechanical components that are involved in the writing and reading of magnetically stored data. In this example, head-disk assembly 20 includes one or more disks 18 having ferromagnetic surfaces (preferably on both sides) that spin about their axis under the control of spindle motor 14. Multiple read/write head assemblies 15a, 15b are movable by actuator 17, and are coupled to preamplifier and write driver function 11. On the read side, preamplifier and write driver function 11 receives sensed currents from read/write head assemblies 15a, 15b in disk read operations, and amplifies and forwards signals corresponding to these sensed currents to data channel circuitry 4 in disk drive controller 7. On the write side, write driver circuitry within preamplifier and write driver function receives data to be written to a particular location of disk 18 from data channel 4, and converts these data to the appropriate signals for writing to disk 18 via read/write head assemblies 15a, 15b. Other circuit functions may also be included within the functional block labeled preamplifier and write driver function 11, including circuitry for applying a DC bias to the magnetoresistive read head in read/write head assemblies 15a, 15b, and also fly height control circuitry for controllably heating read/write head assemblies 15a, 15b to maintain a constant fly height, as described in U.S. Patent Application Publication No. US 2005/0105204 A1, published May 19, 2005 based on an application by Bloodworth et al., assigned to Texas Instruments Incorporated and incorporated herein by reference.

In this example, power management circuit 5 is also included within disk drive controller 7. Servo control 6 is realized within power management circuit 5, and communicates with motion and power controller 8, which drives voice coil motor 12 and spindle motor 14 in head-disk assembly 20. As known in the art, these motors 12, 14 spin disks 18 about their axis and position actuator 17, respectively, so that read/write heads 15a, 15b are positioned at the desired location of disks 18 according to an address value communicated by controller 13. Accordingly, signals from motion and power control function 8 in controller 5 control spindle motor 14 and voice coil motor 12 so that actuator 17 places the read/write head assemblies 15a, 15b at the desired locations of disk surface 18 to write or read the desired data. Power management circuit 5, according to this preferred embodiment of the invention, also includes power management function 10 that receives power from computer 2 on line PWR as shown in FIG. 1; line PWR may be a power line of bus B, or may be a separate power connection to the power supply of computer 2. Power management function 10 includes one or more voltage regulators, by way of which it generates and controls various voltages within disk drive controller 7 and also within head-disk assembly 20.

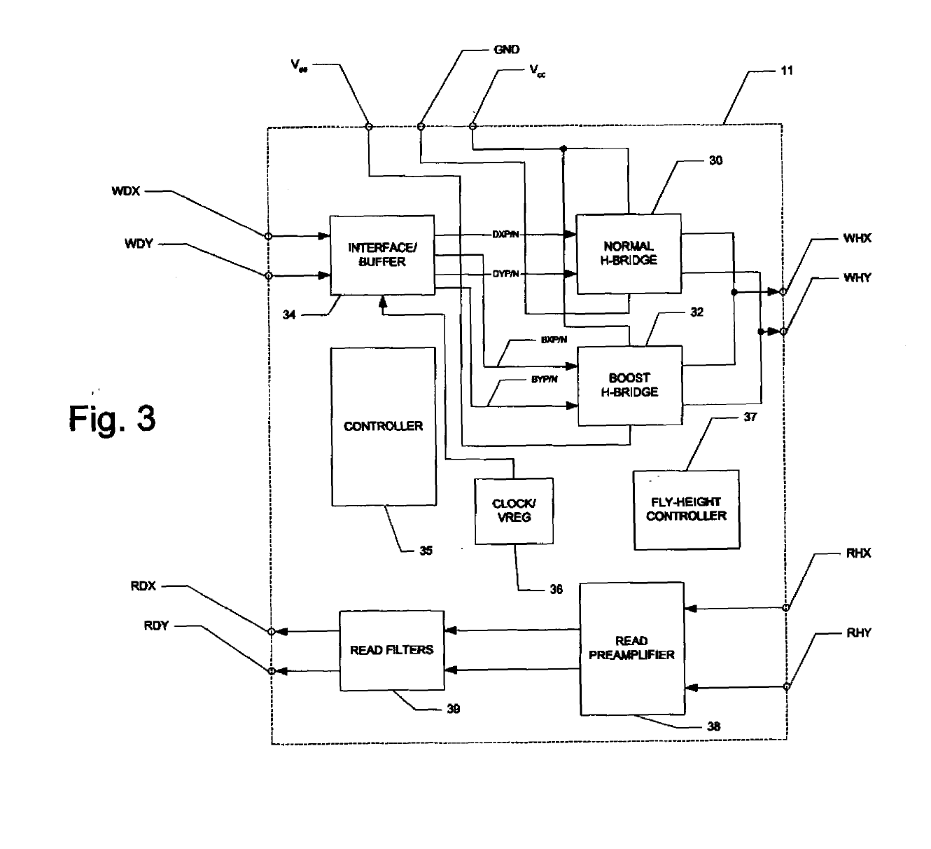

Referring now to FIG. 3, an example of the overall architecture of preamplifier and write driver function 11 in head-disk assembly 20, according to the preferred embodiment of the invention. It is contemplated that this architecture is merely an example of how preamplifier and write driver function 11 may be realized, and that those skilled in the art having reference to this specification will be readily able to implement this invention according to variations of this architecture, or other architectures, without undue experimentation. In addition, the architecture of FIG. 3 is shown for the example of a single read/write head; it is of course well known in the art that conventional preamplifier and write driver functions commonly control multiple read/write heads, especially in disk drive systems that utilize multiple disk platters as are common in the art. This example of preamplifier and write driver function 11 is provided to explain the context of the preferred embodiment of the invention, and therefore is not intended to limit the scope of this invention.

As shown in FIG. 3, preamplifier and write driver function 11 functions both in the write data path (computer 2 to disk 18) and in the read data path (disk 18 to computer 2). On the read side, read preamplifier 38 is connected to terminals RHX, RHY, which are to be connected to the read head (e.g., magnetoresistive head) within a read/write head assembly 15. Amplified signals from read preamplifier 38 are filtered as desired, and presented at terminals RDX, RDY as a differential signal communicated to data channel 4 in disk drive controller 7.

On the write side of preamplifier and write driver function 11, terminals WDX, WDY receive differential signals from data channel 4, corresponding to data to be written to a particular location of disk 18. Interface/buffer 34 receives these signals, and amplifies and formats them for application to normal H-bridge 30 (via signals DXP, DXN, DYP, DYN), and to boost H-bridge 32 (via signals BXP, BXN, BYP, BYN), according to the preferred embodiment of the invention. The timing and voltages of the signals applied to normal H-bridge 30 and boost H-bridge 32, according to this embodiment of the invention, is controlled by clock and voltage regulator circuitry 36, and indirectly by controller 35, in such a manner as to reduce the power dissipation required for the writing of data to disk 18. In addition, clock and voltage regulator circuitry 36 produces the appropriate reference voltages for controlling current sources within normal H-bridge 30 and boost H-bridge 32, in the conventional manner.

Controller 35 is preferably implemented by programmable or custom logic, and controls the operation of preamplifier and write driver function 11. Such control functions performed by controller 35 include between read and write mode, selection of one of multiple read/write heads if preamplifier and write driver function 11 drives multiple heads, communication of status and control information over a serial link to disk drive controller 7, fault processing (e.g., detection of low power supply voltage, low frequency, open and short heads, etc.), and the like, in addition to control of the functionality of the read and write operations. These control functions may be realized on a single processor function, or alternatively may be distributed within preamplifier and write driver function 11. It is contemplated that those skilled in the art having reference to this specification will be readily able to realize the appropriate control functions performed by controller 35, using conventional hardware and software techniques, without undue experimentation.

Other functions related to the operation and control of the disk drive system may also be realized within preamplifier and write driver function 11. One such function is illustrated in FIG. 3 by way of fly height controller 37, an example of which is described in the above-incorporated U.S. Patent Application Publication No. US 2005/0105204 A1.

As shown in FIG. 3, normal H-bridge 30 is powered by the V_{cc} power supply, and is biased between the V_{cc} power supply and ground level GND. By way of example, a nominal voltage for the V_{cc} power supply is +5.0 volts above ground GND. Boost H-bridge is also powered from the V_{cc} power supply, but is biased between the V_{cc} power supply and the Vₑₑ power supply. A nominal voltage for the Vₑₑ power supply is −3.0 volts relative to ground GND. This difference in bias voltages between normal H-bridge 30 and boost H-bridge 32, as reflected in the construction of each, provides important benefits in allowing adequate overshoot current and head launch voltage, while reducing the power consumption of the write drivers.

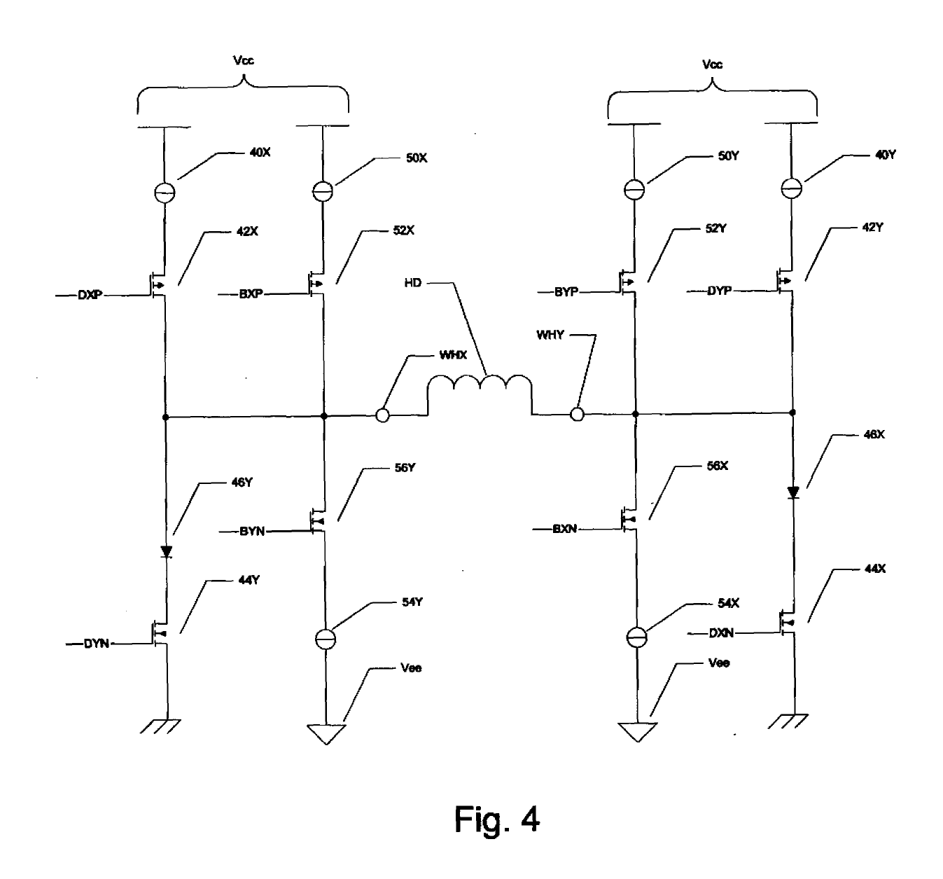

Referring now to FIG. 4, the construction of normal H-bridge 30 and boost H-bridge 32 according to the preferred embodiment of the invention will now be described. While the devices associated with normal H-bridge 30 and boost H-bridge 32 are shown as somewhat distributed among one another at the transistor level shown in FIG. 4, their functional operation will be apparent from the description below.

Normal H-bridge 30 includes p-channel metal-oxide-semiconductor (MOS) transistor 42X, having its drain connected to terminal WHX, and its source connected to the V_{cc} power supply through current source 40X. Current source 40X (as well as the other current sources 40Y, 50X, 50Y, 54X, 54Y in normal H-bridge 30 and boost H-bridge 32) is preferably constructed in the conventional manner, such as by way of an MOS transistor of a selected size (i.e., drive capability) and with its gate biased by a reference voltage from clock and voltage regulator circuitry 36, to conduct a selected stable and regulated current; of course, bipolar transistors or other devices may be used to construct these current sources, as well as transistors 42, 52 (and 44, 56) themselves. Similarly, normal H-bridge 30 also includes p-channel MOS transistor 42Y, which has its drain connected to terminal WHY and its source coupled to the V_{cc} power supply via current source 40Y. The gates of transistors 40X, 40Y receive control signals DXP, DYP, respectively, from interface/buffer 34.

On the pull-down side of normal H-bridge 30 according to this preferred embodiment of the invention, diode 46Y has its anode connected to terminal WHX. N-channel MOS transistor 44Y has its drain connected to the cathode of diode 46Y, and has its source at system ground (GND of FIG. 3). Similarly, diode 46X has its anode connected to terminal WHY. N-channel MOS transistor 44X has its drain connected to the cathode of diode 46X, and its source at system ground (GND). The gates of transistors 44Y, 44X are controlled by signals DYN, DXN, respectively, from interface/buffer 34.

Boost H-bridge 32 includes, on its pull-up side, p-channel MOS transistor 52X that has its drain connected to terminal WHX, and its source coupled to the V_{cc} power supply via current source 50X, and 1-channel MOS transistor 52Y that has its drain connected to terminal WHY, and its source coupled to the V_{cc} power supply via current source 50Y. On the pull-down side, n-channel MOS transistor 56Y has its drain connected to terminal WHX, and its source coupled to the Vₑₑ power supply via current source 54Y; n-channel MOS transistor 56X has its drain connected to terminal WHY, and its source coupled to the Vₑₑ power supply via current source 54X. The gates of transistors 52X, 52Y, 56Y, 56X are controlled by signals BXP, BYP, BYN, BXN, respectively, issued from interface/buffer 34.

As mentioned above, current sources 40X, 40Y, 50X, 50Y, 54X, and 54Y are constructed in the conventional manner, and controlled so that the currents applied to terminals WHX, WHY are at the desired levels. In the operation of normal H-bridge 30 and boost H-bridge 32, one of terminals WHX, WHY is pulled up to the V_{cc} power supply, while the other terminal is pulled down to ground GND, and to the Vₑₑ power supply during boost periods, as will be described above. As will be apparent from the following description, the pull-down current sources 54Y, 54X must be sufficiently sized to conduct both the steady-state and boost currents during such time as associated transistors 56Y, 56X are on. In other words, current source 54Y must have sufficient capacity to conduct the sum of the currents sourced by current sources 40Y, 50Y, and current source 54X must have sufficient capacity to conduct the sum of the currents sourced by current sources 40X, 50X.

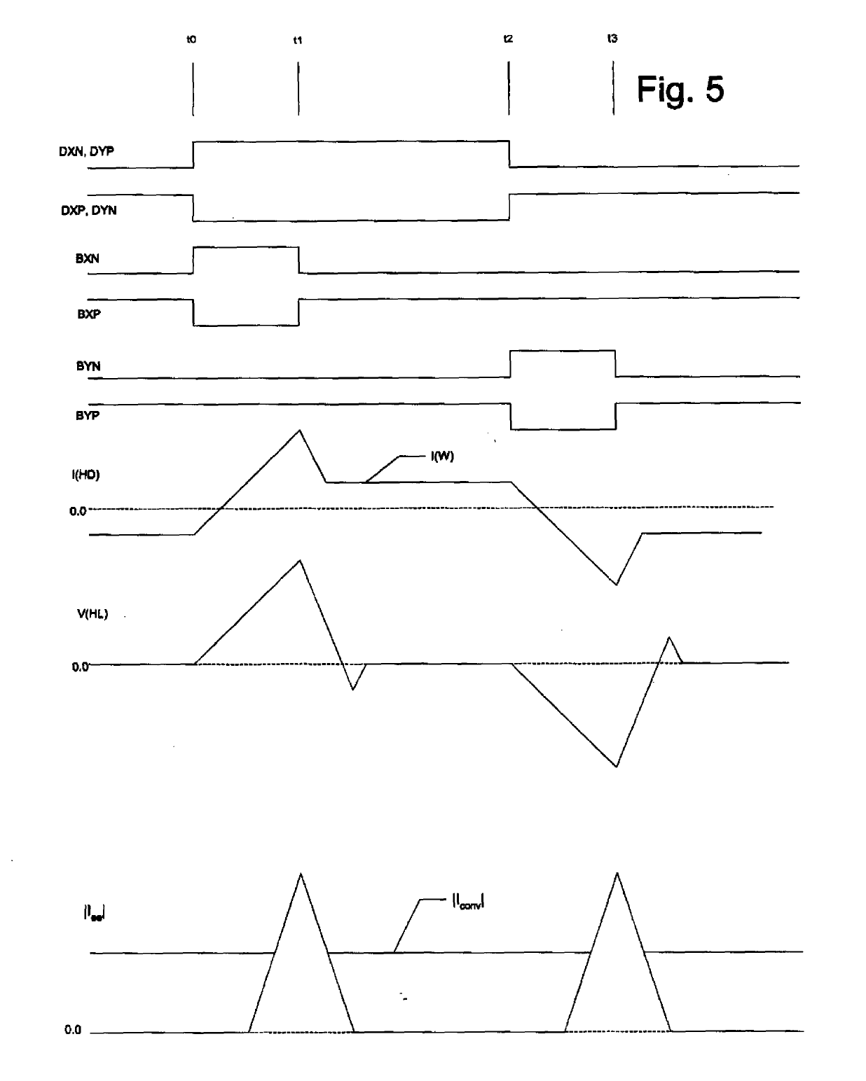

Referring now to FIG. 5, the operation of normal H-bridge 30 and boost H-bridge 32 according to the preferred embodiment of the invention will now be described. As discussed above, it is contemplated that other circuitry within preamplifier and write driver function 11 will generate and control the signals applied to the gates of the transistors in normal H-bridge 30 and boost H-bridge 32, according to this embodiment of the invention. For example, as shown in FIG. 3, it is contemplated that interface/buffer 34 will apply the appropriate control signals to these transistors, based on the differential signal applied to terminals WDX, WDY by data channel 4, with the timing of these signals controlled by controller 35 and clock and voltage regulator function 36, according to the operation described below. It is contemplated that those skilled in the art will be readily able to construct the appropriate control and timing logic for generating these signals, to operate normal H-bridge 30 and boost H-bridge 32 in a manner consistent with the preferred embodiment of the invention described below, and variations thereof.

In the example of FIG. 5, at time t0, normal H-bridge 30 and boost H-bridge 32 begin a write cycle in which a positive current (in the direction from terminal WHX to terminal WHY) will be applied by normal H-bridge 30 and boost H-bridge 32. To accomplish this via normal H-bridge 30, lines DXN and DYP are driven high to turn on transistor 44X and turn off transistor 42Y, respectively, and lines DXP and DYN are driven low to turn on transistor 42X and turn off transistor 44Y, respectively. A “steady-state” current is thus applied through head HD from the V_{cc} power supply, through p-channel transistor 42X; transistor 44X is also on, permitting this current to be conducted to ground GND, so long as diode 46X is forward-biased. According to this preferred embodiment of the invention, boost H-bridge 32 is also activated beginning at time t0, with line BXN driven high and line BXP driven low to turn on both of transistors 52X and 56X; lines BYN and BYP are maintained low and high, respectively, so that transistors 52Y, 56Y are held off. Current is thus conducted from the V_{cc} power supply through transistor 52X, and through transistor 56X to the Vₑₑ power supply.

The combination of transistors 52X and 56X being on along with transistors 42X, 44X continues from time t0 until time t1. During this time, the currents defined by current sources 40X, 50X are conducted from the V_{cc} power supply through head HD, from terminal WHX to terminal WHY. On the pull-down side, because the Vₑₑ power supply is lower in voltage than ground GND, diode 46X will eventually reverse-bias; at that time, all of the current sourced through current sources 40X, 50X is conducted through transistor 56X and current source 54X (to maintain diode 46X reverse-biased). As mentioned above, current source 54X is preferably sized and controlled so as to conduct that combined current.

At time t1, the boost period ends, with line BXN returning low and line BXP driven high, turning off transistors 52X, 56X. The steady-state portion of the write operation continues, however, with transistors 42X and 44X remaining on. The current from the V_{cc} power supply, as controlled by current source 40X, is applied by transistor 42X, and conducted through diode 46X (now forward-biased again) through transistor 44X to ground GND. This steady-state portion of the write operation continues until time t2 when, in this example, another write operation begins, writing data of the opposite data state (current from terminal WHY to terminal WHX). The operation for the writing of this opposite data state is essentially identical with that described above, except with the opposite transistors in normal H-bridge 30 and boost H-bridge 32 being turned on, as compared with the previous example.

FIG. 5 illustrates the overshoot provided by boost H-bridge 32 in this example. Prior to time t0, a negative current I(HD) is conducted through head HD (i.e., a current from terminal WHY to terminal WHX). At time t0, with both the steady-state write current and the boost current applied, current I(HD) is driven to a positive polarity; the rate at which current I(HD) increases following time t0 depends primarily on the inductance of head HD, which is of course substantial in this application. This current I(HD) is thus the sum of the currents of current sources 40X and 50X, and increases rapidly. In addition, the “head launch” voltage V(HL) (defined as voltage above a steady-state level) illustrated in FIG. 5 also increases from its steady-state value; the ability of head launch voltage V(HL) to move as shown permits the application of the boost current to head HD, as shown by the plot of current I(HD).

At time t1, as discussed above, boost H-bridge turns off, with transistors 52X and 56X being turned off. The current I(HD) through head HD is thus limited to the current of current source 40X, as shown by steady-state current I(W) of FIG. 5, which is conducted at a time slightly following time t1. The overshoot current applied through boost transistors 52X, 56X is thus evident from FIG. 5, as the peak of current above this steady-state current I(W).

However, from the standpoint of power dissipation, this steady-state current I(W) following time t1 is conducted only from the V_{cc} power supply to ground GND, and not to the Vₑₑ power supply. As such, the power dissipation (current times voltage) of the write driver circuitry is reduced considerably over much of the write operation. Between time t1 and time t2, the steady-state current I(W) is conducted across the voltage of the V_{cc} power supply only (e.g., 5 volts to ground), rather than across the voltage of the V_{cc} power supply relative to the Vₑₑ power supply (e.g., 5 volts to −3 volts, or 8 volts total). This is illustrated by the plot of the current |Iₑₑ|, which is the absolute value of the current into the Vₑₑ power supply, as shown in FIG. 5. Between the peak currents as shown, according to the preferred embodiment of the invention, the current into the Vₑₑ power supply drops to zero; on the other hand, according to conventional circuits such as shown above relative to FIG. 1, a substantial current |I_{conv}| is conducted to the Vₑₑ power supply throughout the write operation. Considering a typical example in which the boost period is one-third of the total operation period, the power consumed by the write driver circuitry is thus reduced by over 35% over two-thirds of the write operation.

In addition, as evident from this preferred embodiment of the invention, the V_{cc} power supply voltage applied to normal H-bridge 30 and boost H-bridge 32 can be optimized to provide sufficient head launch voltage for high data rate operation, without greatly impacting the power consumption of the write drivers, especially in low data rate situations in which the overshoot period occupies a proportionally smaller fraction of the overall write cycle. This ensures efficient and accurate writing of data to the disk by providing sufficient overshoot current, while minimizing the power consumed during steady-state portions of the write operation.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A write driver for a disk drive, comprising:
a first H-bridge driver, comprising:
a first pull-up transistor, having a conduction path coupled between a first power supply and a first output terminal, and having a control terminal;
a first pull-down transistor, having a conduction path and having a control terminal;
a first pull-down diode, connected in series with the conduction path of the first pull-down transistor between a second output terminal and a first reference voltage;
a second pull-up transistor, having a conduction path coupled between the first power supply and the second output terminal, and having a control terminal;
a second pull-down transistor, having a conduction path and having a control terminal; and
a second pull-down diode, connected in series with the conduction path of the second pull-down transistor between the first output terminal and the first reference voltage; and
a second H-bridge driver, comprising:
a third pull-up transistor, having a conduction path coupled between the first power supply and the first output terminal, and having a control terminal;
a third pull-down transistor, having a conduction path coupled between the second output terminal and a second reference voltage, and having a control terminal;
a fourth pull-up transistor, having a conduction path coupled between the first power supply and the second output terminal, and having a control terminal; and
a fourth pull-down transistor, having a conduction path coupled between the first output terminal and the second reference voltage;
wherein the voltage difference between the first power supply and the first reference voltage is less than the voltage difference between the first power supply and the second reference voltage.

2. The write driver of claim 1, further comprising:
a first pull-up current source connected in series with the conduction path of the first pull-up transistor between the first power supply and the first output terminal;
a second pull-up current source connected in series with the conduction path of the second pull-up transistor between the first power supply and the second output terminal;
a third pull-up current source connected in series with the conduction path of the third pull-up transistor between the first power supply and the first output terminal;
a fourth pull-up current source connected in series with the conduction path of the fourth pull-up transistor between the first power supply and the second output terminal;
a first pull-down current source connected in series with the conduction path of the third pull-down transistor between the second output terminal and the second reference voltage, the first pull-down current source for conducting a current corresponding to a sum of the current conducted by the first pull-up current source and the third pull-up current source; and
a second pull-down current source connected in series with the conduction path of the fourth pull-down transistor between the first output terminal and the second reference voltage, the second pull-down current source for conducting a current corresponding to a sum of the current conducted by the second pull-up current source and the fourth pull-up current source.

3. The write driver of claim 1, wherein the pull-up and pull-down transistors each comprise a metal-oxide-semiconductor transistor.

4. The write driver of claim 3, wherein the pull-up transistors each comprise a metal-oxide-semiconductor transistor of a first conductivity type, and wherein the pull-down transistors each comprise a metal-oxide-semiconductor transistor of a second conductivity type opposite from the first conductivity type.

5. The write driver of claim 1, further comprising;
control logic, for generating control signals applied to the control terminals of each of the pull-up and pull-down transistors responsive to received data signals.

6. The write driver of claim 5, wherein the control logic issues control signals responsive to a received data signal at a first data state to turn on the first and third pull-up transistors and the second and fourth pull-down transistors, and to turn off the second and fourth pull-up transistors and the first and third pull-down transistors;
and wherein the control logic issues control signals responsive to a received data signal at a second data state to turn on the second and fourth pull-up transistors and the first and third pull-down transistors, and to turn off the first and third pull-up transistors and the second and fourth pull-down transistors.

7. A method of writing a data state to a magnetic disk, comprising the steps of:
applying a first current from a first power supply voltage to a first terminal coupled to a write coil during a first time period;
during an initial portion of the first time period, applying a second current from the first power supply voltage to the first terminal;
during the initial portion of the first time period, conducting the first and second currents from a second terminal coupled to the write coil to a first reference voltage;
during the portion of the first time period after the initial portion, conducting the first current from the second terminal to a second reference voltage, the second reference voltage being closer to the first power supply voltage than the first reference voltage.

8. The method of claim 7, further comprising:
during the initial portion of the first time period, blocking conduction of current from the second terminal to the second reference voltage.

9. The method of claim 8, wherein the blocking step comprises:
reverse-biasing a diode.

10. The method of claim 7, wherein the applying and conducting steps are performed responsive to receiving a data signal at a first data state;
and further comprising, responsive to receiving a data signal at a second data state:
applying a third current from the first power supply voltage to the second terminal during a second time period;
during an initial portion of the second time period, applying a fourth current from the first power supply voltage to the second terminal;
during the initial portion of the second time period, conducting the third and fourth currents from the first terminal to the first reference voltage;
during the portion of the second time period after the initial portion, conducting the third current from the first terminal to the second reference voltage.

11. A disk drive system, comprising:
a disk platter having a magnetic surface;
a write head disposed near the magnetic surface of the disk platter;
a data channel for receiving, from a host, data to be written to a location of the disk platter; and
write driver circuitry, comprising:
a first H-bridge driver, comprising:
a first pull-up transistor, having a conduction path coupled between a first power supply and a first side of the write head, and having a control terminal;
a first pull-down transistor, having a conduction path and having a control terminal;
a first pull-down diode, connected in series with the conduction path of the first pull-down transistor between a second side of the write head and a first reference voltage;
a second pull-up transistor, having a conduction path coupled between the first power supply and the second side of the write head, and having a control terminal;
a second pull-down transistor, having a conduction path and having a control terminal; and
a second pull-down diode, connected in series with the conduction path of the second pull-down transistor between the first side of the write head and the first reference voltage;
a second H-bridge driver, comprising:
a third pull-up transistor, having a conduction path coupled between the first power supply and the first side of the write head, and having a control terminal;
a third pull-down transistor, having a conduction path coupled between the second side of the write head and a second reference voltage, and having a control terminal;
a fourth pull-up transistor, having a conduction path coupled between the first power supply and the second side of the write head, and having a control terminal; and
a fourth pull-down transistor, having a conduction path coupled between the first side of the write head and the second reference voltage; and
control logic, for generating control signals applied to the control terminals of each of the pull-up and pull-down transistors responsive to signals from the data channel;
wherein the voltage difference between the first power supply and the first reference voltage is less than the voltage difference between the first power supply and the second reference voltage.

12. The system of claim 11, further comprising:
a first pull-up current source connected in series with the conduction path of the first pull-up transistor between the first power supply and the first side of the write head;
a second pull-up current source connected in series with the conduction path of the second pull-up transistor between the first power supply and the second side of the write head;
a third pull-up current source connected in series with the conduction path of the third pull-up transistor between the first power supply and the first side of the write head;
a fourth pull-up current source connected in series with the conduction path of the fourth pull-up transistor between the first power supply and the second side of the write head;
a first pull-down current source connected in series with the conduction path of the third pull-down transistor between the second side of the write head and the second reference voltage, the first pull-down current source for conducting a current corresponding to a sum of the current conducted by the first pull-up current source and the third pull-up current source; and
a second pull-down current source connected in series with the conduction path of the fourth pull-down transistor between the first side of the write head and the second reference voltage, the second pull-down current source for conducting a current corresponding to a sum of the current conducted by the second pull-up current source and the fourth pull-up current source.

13. The system of claim 11, wherein the pull-up and pull-down transistors each comprise a metal-oxide-semiconductor transistor.

14. The system of claim 13, wherein the pull-up transistors each comprise a metal-oxide-semiconductor transistor of a first conductivity type, and wherein the pull-down transistors each comprise a metal-oxide-semiconductor transistor of a second conductivity type opposite from the first conductivity type.

15. The system of claim 11, wherein the control logic issues control signals responsive to a received data signal at a first data state to turn on the first and third pull-up transistors and the second and fourth pull-down transistors, and to turn off the second and fourth pull-up transistors and the first and third pull-down transistors;
and wherein the control logic issues control signals responsive to a received data signal at a second data state to turn on the second and fourth pull-up transistors and the first and third pull-down transistors, and to turn off the first and third pull-up transistors and the second and fourth pull-down transistors.
